(19) United States
(12) Patent Application Publication
(10) Pub. No.: US 2025/0145037 A1
(43) Pub. Date: May 8, 2025

(54) ADVANCED SMART MULTI SPEED ELECTRICAL GENERATOR FOR ELECTRIC VEHICLES

(71) Applicant: MORTEZA PAZHOHANDEH, Tehran (IR)

(72) Inventor: MORTEZA PAZHOHANDEH, Tehran (IR)

(21) Appl. No.: 18/931,580

(22) Filed: Oct. 30, 2024

Related U.S. Application Data
(60) Provisional application No. 63/595,413, filed on Nov. 2, 2023.

(51) Int. Cl. B60L 53/52; B60L 53/57; H02J 7/14; H02K 7/18

(52) U.S. Cl. CPC B60L 53/52; B60L 53/57; H02J 7/14; H02K 7/183

(57) ABSTRACT

An electrical generation system for a vehicle includes a turbine assembly coupled to the vehicle in association with a central gearbox and electrical generator. The turbine assembly is located within a housing having a baffle assembly configured to selectively actuate so as to regulate the flow of air into the housing. The turbine assembly is downstream of the baffle assembly and configured to receive the flow of air in the housing. The turbine assembly includes turbine blades configured to generate electrical energy through rotation of the turbine blades as a result of the flow of air. The turbine blades rotate about a central shaft. The central gearbox is coupled about the central shaft. The electrical generator is coupled to the central shaft so as to selectively rotate and generate the electrical energy.

### CROSS REFERENCE TO RELATED APPLICATIONS

This application claims the benefit of an earlier filing date and right of priority to U.S. Provisional Application No. 63/595,413, filed 2 Nov. 2023, the contents of which is incorporated by reference herein in its entirety.

### BACKGROUND OF THE INVENTION

### 1. Field of the Invention

The present application relates to a wind power generation system, and more particularly to a system configured to capture electrical energy from air passing around a vehicle especially the wind created by a vehicle's motion.

### 2. Description of Related Art

Electric cars have a long and storied history that dates back to the late 1800s. In fact, the first electric car was developed in the 1830s, long before gasoline-powered cars were even a concept. However, it wasn't until the early 1900s that electric cars gained popularity, with manufacturers such as Baker, Detroit Electric, and Edison Electric producing them in large numbers. These early electric cars were popular with women, as they were clean, quiet, and easy to operate. However, the rise of the internal combustion engine and the availability of cheap gasoline led to a decline in the popularity of electric cars by the 1920s.

Electric cars made a comeback in the 1990s, when manufacturers such as General Motors, Toyota, and Nissan began producing electric cars in response to concerns about air pollution and dependence on oil. However, these early electric cars suffered from limited range, high cost, and lack of public charging infrastructure, which made them unattractive to most consumers. In recent years, advances in battery technology, lower costs, and greater availability of charging infrastructure have led to a resurgence in the popularity of electric cars, with many major manufacturers now offering fully electric models.

Despite their many advantages over traditional gasoline-powered cars, current electric vehicles still face several limitations that affect their range and performance. One of the main challenges is the limited battery capacity, which determines how far the vehicle can travel on a single charge. Even with advancements in battery technology, most electric cars can only go up to 300 miles before needing to recharge, which can be inconvenient and time-consuming.

Another limitation of current electric cars is their dependence on external charging infrastructure, which is not always available or easily accessible. In urban areas, for example, finding a charging station can be a challenge, and in rural or remote areas, the lack of charging infrastructure can make electric vehicles impractical or even impossible to use. This limitation also affects the reliability and durability of electric cars, as battery life and performance can be affected by the quality and availability of charging options.

Although strides have been made with respect to the electrification of vehicles, shortcomings remain. It is desired that a system be provided that is configured to work with electric vehicles to capture electrical energy from air passing around a vehicle, especially the wind created by a vehicle's motion to improve the vehicle range and performance of the electric vehicle.

### BRIEF SUMMARY OF THE INVENTION

It is an object of the present application to provide a vehicle with the means capable of capturing wind energy from a vehicle. An airflow regulator is used to capture the wind energy as a result of the vehicle's motion. Wind turbines are selectively rotated at various speeds to generate energy from the wind. When coupled to an electric vehicle, it may be used to improve vehicular performance and range of the electric vehicle.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a front perspective view of a vehicle with an electrical power generation system according to an embodiment of the present application.

FIG. 2 is a partial cutaway side view of the electrical power generation system of FIG. 1.

FIG. 3 is an enlarged front perspective view of a turbine assembly in the electrical power generation system of FIG. 2.

FIG. 4 is a front perspective view of a turbine in the turbine assembly of FIG. 3.

FIG. 5 is a side view of the turbine of FIG. 4.

FIG. 6 is side view of the vehicle with the electrical power generation system of FIG. 1.

FIG. 7 is a top view of the vehicle with electrical power generation system of FIG. 1.

FIG. 8 is an alternate embodiment of the electrical power generation system of FIG. 1 in a door of the vehicle.

FIG. 9 is an enlarged view of the electrical power generation system of FIG. 8.

While the application is susceptible to various modifications and alternative forms, specific embodiments thereof have been shown by way of example in the drawings and are herein described in detail. It should be understood, however, that the description herein of specific embodiments is not intended to limit the application to the particular forms disclosed, but on the contrary, the intention is to cover all modifications, equivalents, and alternatives falling within the spirit and scope of the application as described herein.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

The electrical generation system of the present application is configured to be installed in different types of vehicles to capture wind energy. The system, when installed in the air flow of a moving vehicle, will recover energy created by captured moving air, and subsequently convert it to electrical power by passing it through rotatable wind turbine blades. These turbine blades surround a central gearbox and electrical generator to produce additional power for charging the electric vehicle. The power is clean and efficient and a multi speed gearbox controls the output of the unit at varying speeds. The system may be installed in various locations on a vehicle but ideally in locations with access to the oncoming air flow. Examples of such suitable locations may include under the front hood, in doors through one or more vents, or even in the roof of the vehicle via a scoop by recovering the wasted wind energy created by a moving vehicle. The system of the present application will enhance the value, range, and durability of the vehicle.

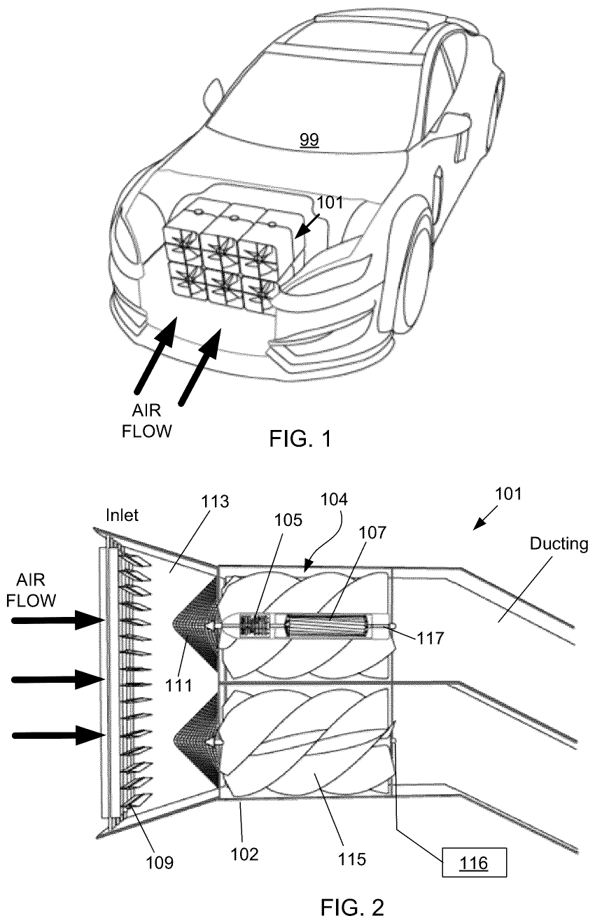

Referring now to FIG. 1 in the drawings, a front perspective view of a vehicle incorporating an electrical generation system 101 is illustrated. Portions of the front of the vehicle 99 are removed for illustration purposes so as to visualize the system 101 of the present application. Air is configured to pass through the front grill of the vehicle and through one or more electrical generation systems 101. As the air passes through the turbines within each system 101, the turbines rotate thereby inducing an electrical benefit to the system of the vehicle. In this manner a car captures electrical energy that may be used to subsequently power the vehicle. By harnessing external wind produced as the vehicle moves, the vehicle may experience extended ranges of operation and charging of batteries. It is understood that the vehicle does not necessarily have to be in motion for system 101 to function. A stationary vehicle that happens to be facing a head on wind may achieve the same benefits.

Referring now also to FIG. 2 in the drawings, a partial side view of system 101 is illustrated. In this view there are two turbine assemblies, each turbine assembly is held within a housing 102. It is understood that system 101 is operable with a single turbine assembly but for purposes herein two turbine assemblies are illustrated as one is partially cut away to illustrate an internal central gearbox 105 and electrical generator 107. Air that is passing by, around, or through vehicle 99 is captured or routed into system 101. The air may be captured through any one of scoops, vents, grills, or deflectors for example.

Air is configured to pass through vertical and/or horizontal smart baffle assembly 109, which may take the form of louvers, to control the flow into each turbine assembly. Assembly 109 is coupled to housing 102 at an inlet of the turbine assembly. Assembly 109 acts as a smart diaphragm within system 101 and is configured to regulate the amount of air passing there through. Assembly 109 is configured to selectively actuate between open and closed positions so as to regulate the amount of air passing into the inlet and housing. After passing the assembly 109, the air passes through one or more protective steel screens 111 within housing 102. Screens 111 are used to filter out and restrict the passage of debris or other small items from entering the turbine assemblies. Between assembly 109 and screens 111, system 101 may include a shroud 113 or other angled ducting used to funnel or accelerate the air toward the turbine assemblies.

Each turbine assembly 104 includes a turbine 115, an electrical generator 107, and a central gearbox 105. As the air flow is routed through the turbine assemblies, the turbine 115 is rotated around a central axis defined through shaft 117. In communication with central shaft 117 is gearbox 105 and an electrical generator 107. Gearbox 105 is configured to selectively adjust the speed of rotation of central shaft 117 in relation to the speed of rotation of turbine 115. Rotation of the turbine 115 rotates a central shaft 117 which passes through gearbox 105 so as to generate electrical energy within generator 107. This energy may be routed to a central storage such as a battery supply 116.

System 101 improves the performance and range of electric vehicles by harnessing the energy in the wind around them. Additionally, it can recover energy, making it a more efficient use of energy. Battery supply 116 may be shared with the vehicle battery power supply such that system 101 directly feeds generated electrical energy to the vehicle batteries to selectively accelerate the vehicle. It is understood that the generated electrical energy needs to be stored or used immediately after generation. A power supply with system 101 alone is an option or where system 101 is directly connected to the vehicle power supply.

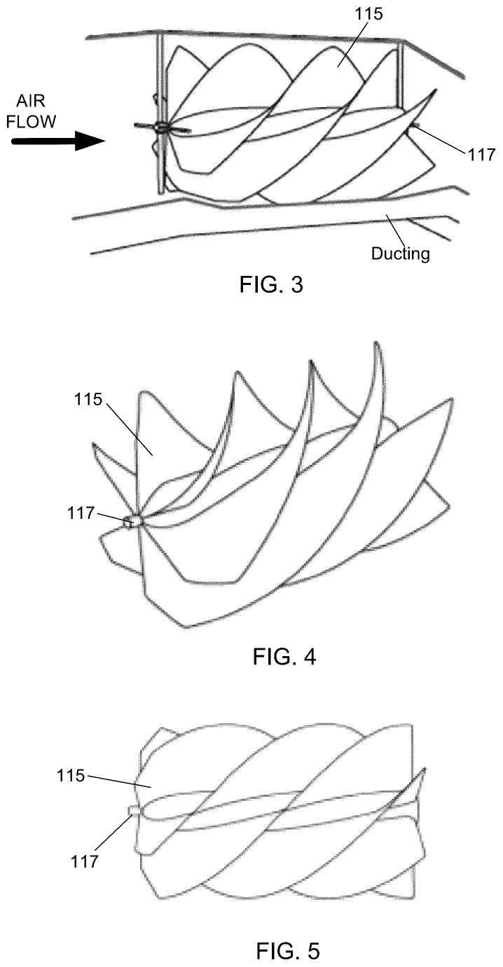

Referring now also to FIGS. 3-5 in the drawings, assorted views of the turbine assembly are provided. The turbine assembly may include the turbine blades themselves along with the gearbox and generator. The central shaft is included so as to provide a central rotating point for the blades. The turbine assembly may be supported within ductwork both before and or after the turbine assemblies. It is understood that this is one type of embodiment for the turbine assemblies and that others may also exist.

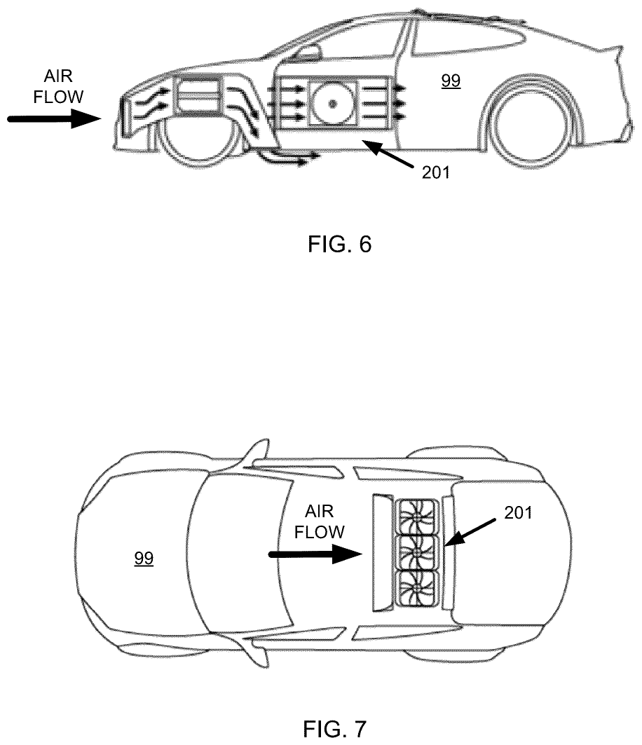

Referring now also to FIGS. 6 and 7 in the drawings, a secondary embodiment of system 101 is illustrated. In these figures turbine assemblies are located in different locations on vehicle 99. As seen from the drawings, turbine assemblies may be located in other locations such as the roof of the vehicle 99 as well as side panels. As understood, vehicle 99 has less depth between an exterior surface and an interior surface in such positions. This necessitates a design change to the overall appearance of system 101. The overall concept of system 101 remains the same. In this embodiment, the blades of the turbine use slimmer high strength aluminum or other polymer to form turbine blades. The blades may extend further away from the axis and would be of necessity more shallow in depth. As seen in FIGS. 1-5 of the drawings, shaft 117 was parallel with the flow of air. In contrast, the embodiments of FIGS. 6-7 illustrate where the central shaft is perpendicular to the flow of air. Placement of system 101 on the vehicle will determine partly the orientation of the central shaft to that of the flow of air, being anywhere between perpendicular to fully parallel.

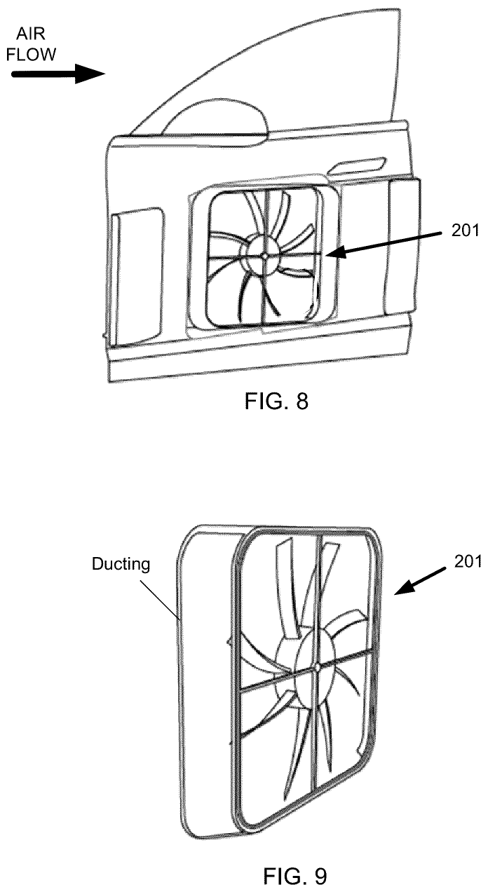

Referring now also to FIGS. 8 and 9 in the drawings. It is understood that system 101 may be configured to accept air flow from one or more directions. As seen in FIGS. 1-5 wherein the air flow was relatively axially aligned (parallel) with the turbine assemblies and flow of air, in FIGS. 6-9, the air flow reaches the turbine assembly from a side offset from the axis of rotation, relatively perpendicular to the flow of air. In FIG. 8, air flow is directed through a vent in the door which is then passed through the turbine assembly. In FIG. 9 is an enlarged view of the turbine assembly seen in FIG. 8. The side of the turbine assembly and housing is open on its side offset from the axis of rotation.

Electrical generation system 201 is similar in form and function to that of system 101. The passage of air across any portion of the turbine blades induces rotation across an axis which in turn facilitates the generation of electrical power. In any embodiment, wind turbines work in conjunction with the baffle assembly, which in turn controls the amount of air flow, and the turbines spin to produce power. The turbines are gear-controlled by a gearbox on their center axle, which is also where the electric generator is mounted. This configuration allows for optimal control and power output to charge the batteries.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. An electrical generation system for a vehicle, comprising:
a housing having a baffle assembly configured to selectively actuate so as to regulate the flow of air into the housing;
a turbine assembly downstream of the baffle assembly and configured to receive the flow of air in the housing, the turbine assembly having turbine blades configured to generate electrical energy through rotation of the turbine blades as a result of the flow of air, the turbine blades rotating about a central shaft;
a central gearbox within the turbine assembly coupled about the central shaft; and
an electrical generator within the turbine assembly and coupled to the central shaft so as to selectively rotate and generate the electrical energy.

2. The system of claim 1, wherein the central shaft is parallel to the flow of air in the housing.

3. The system of claim 1, wherein the central shaft is perpendicular to the flow of air in the housing.

4. The system of claim 1, wherein the housing includes a screen located upstream from the turbine assembly, the screen configured to filter out debris from entering the turbine assembly.

5. The system of claim 1, wherein the baffle assembly actuates between an open and a closed orientation.

6. The system of claim 1, further comprising:
a battery supply configured to receive power from the electrical generator.

7. The system of claim 6, wherein the battery supply is in electrical communication with the vehicle.

8. The system of claim 6, further comprising:
a vehicle configured to draw electrical power from the battery supply.

9. The system of claim 8, wherein the battery supply is used to accelerate the vehicle.

10. The system of claim 1, wherein the flow of air passes through the housing when the vehicle is stationary.
